(19) United States
(12) Patent Application Publication
(10) Pub. No.: US 2009/0083268 A1
(43) Pub. Date: Mar. 26, 2009

(54) MANAGING VARIANTS OF ARTIFACTS IN A SOFTWARE PROCESS

(75) Inventors: Regis Coqueret, Balma (FR); Bertrand H. Portier, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 12/235,981

(22) Filed: Sep. 23, 2008

(30) Foreign Application Priority Data
Sep. 25, 2007 (FR) 07301395.5

(51) Int. Cl. G06F 17/30; G06F 7/06

(52) U.S. Cl. 707/6; 707/203; 707/3; 707/E17.045; 707/E17.014

(57) ABSTRACT

In some embodiments the management of revisions to segments of code or artifacts is disclosed. Such management can assist a software developer in the development of software. In some embodiments, a developer can retrieve a versioned file from a repository, modify content of the versioned file to create a variant of the versioned file, compare the variant to the versioned file, and determine a difference between the versioned file and the variant. Then, the one or more attribute can be assigned to the differences and the attributes can be indexed such that the variants can be located in response to a search. In some embodiments variants can be indexed based on a variability point to which they can be matched. Other embodiments are also disclosed.

### CROSS-REFERENCE TO RELATED APPLICATIONS

This document claims priority to an application filed in France, application number 07301395.5 entitled A Method System and Computer Program for Managing Variants of Artifacts when Developing Software Solutions, filed on Sep. 25, 2007.

### BACKGROUND

This disclosure generally relates to development of information technology (IT) solutions and software development. This disclosure also relates to managing variants of artifacts to assist in the development of software solutions.

A software asset can be defined as a set of one or more related artifacts that have been created, purchased or acquired. After an asset is placed in condition for usage it can be utilized to process data or to run a system. In some cases the asset can be called and utilized many times by a system such as an enterprise system. An artifact can be defined generally as a program or segment of computer instructions, possibly one or more models and/or descriptions that are developed and utilized during software development and maintenance. Examples of artifacts can include a specification, requirements, architecture models, design models, source code, executable code, configuration directives, test data, test scripts, process models, project plans, documentation, etc.

A software asset can also be defined as a unit of data which can be source code, models, or other information that can be utilized in software development and as part of an IT related solution. An asset consumer can be a developer of the IT solution. The asset customer can be an architect or a designer of any type of IT solution or business process solution. Examples of solutions can include business solution modeling, analysis utilizing models, and application development design.

A computer industry consortium in the IT industry, called the object management group, is an international, open membership, not-for-profit task force that develops enterprise integration standards for a wide range of technologies and industries. OMG is a trademark of Object Management Group Inc. One standard that the OMG has developed is standardized software asset packaging for selling software.

The OMG promulgates a reusable asset specification (RAS) that defines a set of guidelines and recommendations about the structure, content and descriptions of “reusable” software assets. For example, Version 2.2 of the RAS was published November 2005 by the OMG. The RAS can identify categories of software assets which have consistent packaging. Further, the RAS can support customization of a software asset's “key” point for a software asset consumer. In the RAS, an asset can be defined as a container of artifacts and a variability point can be defined as a point in an artifact which can be modified by the consumer to implement a target solution. For example, the variability support of a RAS can make it possible to utilize only a portion of an asset.

It is beneficial that IT professionals or asset consumers are aware of the variations or customizations (so-called variants) that can be implemented on a specific portion of a solution, project or file to be able to substitute sub-sets, portions, or fragments of projects or files with other fragments of files during the creation or development of software solutions. In one example a segment of Java® code can be substituted for a non-Java segment of code and such a segment ca be considered as a variant. The implementation can be considered a different implementation with the same functionality because the variant is written in Java as opposed to the original segment which may have been written in “C” language.

Variants are very useful. For example, a variant can be implemented merely to make a system compliant to a technical standard. In other examples, a variant can be a very efficient implementation of a process that runs on a specific platform and another variant can be a very efficient implementation but on another specialized platform. In some cases, variants can be defined as different versions of the same software portion (model fragment, code fragment, package, etc. . . . ), providing a similar function where each variant can be substituted (replaced) by other variants in a given context. A variant's context can include a specific location where the substitution should take place (e.g., the location of a Java method in a Java source file).

A service oriented architecture (SOA) can define principles for reuse for code or variants. A SOA can define reuse of components and services and effective sharing of such components. For example, composite applications based on composite business services (CBSs) from International Business Machines (IBM) utilize such a SOA. CBSs can be defined as a collection of pre-configured business applications, services, and processes that can integrate computer processes internal to a business and process external to the business (i.e. processes between the business and vendors or customers). The CBSs can be customized and implement variants such that the CBSs provide efficient and effective services.

In the RAS and in asset repositories, variability points can allow for the definition of “spots” in software assets, where the spots or points can provide locations and directions for inserting variants into an appropriate location in the software structure. RASs or asset repositories typically do not provide a way of specifying what variants (choices) can be inserted into a particular spot. Accordingly, typically all that is known about a variability point is the location where a variant can be placed.

Software version control or tracking products such as “Concurrent Versions System,” “Rational®” or ClearCase®” can provide developers with the ability to develop different components of a software solution simultaneously. Version control applications allow for the management of multiple revisions of the same unit of data. For example, multiple revisions on source code, model or other information, can be made during the development of an IT related solution. A version control system (VCS) or revision control system (RCS) can allow for changes or file revisions in a specific version of a software module to be re-applied to a later version of the software module.

In a VCS with revisions, the information stored by or provided by the VCS may not be presented in a format that can be utilized to substitute variants. For example, a new file version can become the current version when a revision is made to the file. VCS may only support one versioning thread (with revisions or branches) for a particular file. Variants can be different from revisions in the version control systems because with most revisions there is only one “current” revision. Whereas with variants, more than one variant can be currently valid.

Variants may be complete files (e.g., a Java file), but variants can also be file fragments (e.g., a Java method from a Java source file). In one example, a Java code referred to as “HelloWorld.java,” can be put under version control and such control can prevent users from substituting a variant for the HelloWorld script. For example, a programmer would be prevented from substituting the variant “sayHello” because sayHello would be considered a “different” implementation of the “HelloWorld” code. Consequently, sometimes VCSs cannot support variability inside of file artifacts. This often occurs at the Java method level.

The revisions from VCSs can be lost when a software asset is submitted to an asset repository because only the last version or revision is typically packaged in the software asset. Packaging of “all” or numerous versions in the software asset can make the asset invalid. For example, two Java classes with the same name can make an asset invalid unless the asset packaging is dependent on a specific VCS. This dependency on a specific VCS can allow the storage of different revisions of the same class.

The IBM product VisualAge® Pacbase (VAPac) can be defined as software allowing for the analysis, modeling, design, and construction of programs which can solve various problems. VAPac can also be defined as a repository-based environment that covers application development needs from analysis and design, to production and maintenance of e-business and traditional applications. VAPac can provide a response to a problem and allows for repository-based management and reuse of components during the development process across projects.

VAPac's library system can allow for the storage and management of different versions or entity variants, and can make them visible to solution developers. The VAPac repository libraries can be described as hierarchically structured with the hierarchical level of a library corresponding to the general nature of the information the library contains. Descriptions of specifications can be in a user's connection library and also in the higher libraries. Any modification in a given library may impact all of the library's dependent libraries immediately. VAPac can show the user the elements which belong to the selected library, the higher level libraries and optionally, elements which belong to the lower libraries.

Generally, VAPac has a set of proprietary mechanisms, that may not be applied in the generic context of today's software development environments. VAPac can have open source components, open specifications and standards such as extensible mark-up language (XML), web services, popular version control systems (VCSs), etc.

### BRIEF SUMMARY

In some embodiments, artefacts variant management information can be created during software development. A processor operated by a programmer who is developing software solutions can automatically create such management information. The processor can manage software version or revision control and can manage versions of variants or versioned file contents. The disclosed process can allow a processor to retrieve a revision of a file version from the version control system. A user updating module can store a portion of the code that contains revision content of the file version. Accordingly, the user interface can be adapted to interface with version control system to accomplish such a feature.

Variant revisions in file versions can be stored by the version control system. The version control system can also store an indication that indicates one or more differences determined between variant versions and/or variant content. The processor can utilize a log to identify code that contains the variant revisions. In some embodiments, a portion of the code can be updated via input from a traditional user interface and the identifier can be logged by the version control system. Such a process can be transparent to the user.

In other embodiments, when a new variant is coded by the processor the variant revisions can be coded and the identifiers corresponding to the variant revisions can be logged by the system. The new variant and variant revisions can be stored by the version control system in response to signals from the user interface. Such a feature allows for explicit manipulation of variants by the user. In some embodiments, the version control system in response to the user interface can update existing variants with variant revisions where the variant revisions have logged identifiers. A user can make explicit changes or manipulations to a variant via the user interface. The system can select variant content for a specific revision of a file version utilizing the user interface. Such a feature allows for explicit manipulations of variants by the user. One versioned file can be utilized to create a corresponding asset through an asset management system. The variant artefacts can be defined by the variant revisions of the file version for each variability point defined as a portion of file having variants.

In some embodiments, an asset can be created utilizing an asset management system and a versioned file can be conversely coded with variants of the asset. The variant asset can include variability points, and coded variants. Some embodiments can include variant revisions, including one variant revision that can be known as a revision of the file version that does not include a portion of code that corresponds to the variant, and a second revision having a portion of code corresponding to the variant content. A revision of the versioned file can be utilized to retrieve the latest revision of the file version. In some embodiments, a processor can utilize a computer program product having programming code to implement the processes disclosed herein.

In some embodiments, software artefacts variant management can be provided by storing, displaying, localizing, and substituting code or project fragments using a version control system to manage such a process.

In some embodiments, software artefacts variant management can be provided by creating attributes that define something about the segment of code where the attributes can be indexed, organized, stored, displayed, and merged or integrated to manage various versions of code segments. Such management can utilize a version control system and a code repository. Generally, indexing can be described as the process of converting a collection of data about a segment of code or a file, such that the data can be compatible with a relational database and relational database tools. Then database tolls and manipulations can be utilized to manage the code variations. For example a developer can search for code variations and retrieve such variations for use in a program that is being developed.

Variability points can be utilized as variant codifications in an asset repository. Variability points can define new codifications of variants in the version control system and can allow for the mapping from a conceptual variant model to and from an asset repository in the version control system. A conceptual variant model can be organized in memory utilizing Java classes for the different variants.

Software variants can be grouped under software variability points, where each variability point can define the context (location in the software asset) for its variants. In addition, each variability point can group all of the variants that are available for substitution in a specific context.

The software asset repository can store software assets and the software assets can contain variability points and variants. The embodiments can keep track of current and available portions (i.e. fragments of models or code) of software, and can allow for the substitution of these portions at solution development time. Substitutions can be made for requirements, analysis, design, implementation, etc., that are within the problem or solution space.

Some embodiments provide access to displays having different dimensions and classifications of variation within a given file artifact, where the classifications and variations are independently accessible. Each dimension can be codified using a variability point, which group related variations can be presented in the form of variants.

The disclosed solutions may be unique in supporting development-time variations in software at the project, file, or file fragment level, and may allow for the localization, visualization, and substitution of code variations. A revision and/or variant that is developed under a revision control system can be integrated into a software asset and the revisions/variations can be retained when a software asset is moved outside of the version control system. This software asset can be submitted to an asset repository where the repository can store the asset as a “new” software asset, where the asset does not have a revision history.

Additionally, some embodiments can manage variations in software assets by keeping snapshots in time or snapshots of specific versions of the software assets where the entire asset, versions, and variants are available for substitution into other software assets when needed. The disclosed arrangements allows a software developer to efficiently tag, keep or store more than one “version” of a file (or file portion) as a current file. Thus, all versions of a piece of code can be accessed by a software developer and can be substituted into software assets under development. It can be appreciated that the disclosed arrangements provide revision support that has a very fine resolution or granularity. For example revision tracking and substitution can be finer than the file level.

In other examples, variants that are portions or fragments of code, can be managed without limiting a software developer solely to transactions on a whole file, whole artifact or whole variant. This configuration is beneficial because portions or fragments of code, possibly variants may be contained in the same file or in a single file and a developer may only want a single variant from a file containing multiple variants. Such a configuration allows for effective support for software variants during software development by logging different user activities such as transactions by a users' via tools, desktops, version control systems, and standard asset repositories. Logging and storing user driven variant revisions and transactions during code development can provide a future developer with access to useful code, often customized, and supporting information. Such revisions and transactions can be stored in an asset repository.

In some embodiments, a multi-threaded view of the revision history of a software artifact can be created. Such a view can be easily achieved because of the effective logging, codification and search methods disclosed herein. Each thread can be captured as a variability point and the variability point can be utilized to group the variations that are “current” and available for use. In some embodiments, version control systems can be utilized with asset repositories to manage variants and their usage. Some embodiments are legacy compliant and can operate similar to traditional revision control systems.

The management features of some embodiments allow multiple users to simultaneously use the same files and to make revisions to such files creating many revisions of the same basic file or variant. The variant, its corresponding variant definition including variant artifacts, can be managed in the same space, i.e. at the same abstraction level. In some embodiments, supporting variability of entities inside a file allows a software asset to be applied across all stages of the software lifecycle (i.e. development, business plan, requirements, analysis, design, implementation and maintenance).

In some embodiments, a user can be presented with a graphical view of models, such as a unified modeling language (UML) mode. A physical text file can also be displayed under the cover supporting the graphical model. For example, a UML model can be represented with an .emx file. Such a graphical presentation can be provided by an application such as the rational software architect available from IBM. Such an application can allow the disclosed arrangements to be compatible with numerous development artifacts across the development lifecycle or the software asset life cycle.

Modern software development environments utilize a mark up language and provide network compatible interfaces. Such code is typically based on open source code and has open specifications and open standards such. Most environments have a version control system (VCS), also called revision control systems (RCS) and some include Concurrent Versions C=System (CVS), subversions, and Rational ClearCase type applications. Most modern development environments can be geographically distributed allowing distributed teams to leverage collaboration technologies such as network communications. The majority of modern software development environments are capable of supporting the construction of SOA solutions using efficient sharing and reuse of components and services. For example, composite business services can be provided by the IBM WebSphere® and business services fabric applications.

### BRIEF DESCRIPTION OF THE SEVERAL VIEWS OF THE DRAWING

FIG. 1 is a flowchart depicting methods for managing variants of artifacts in developing software;

FIG. 2 is a flowchart illustrating methods for usage and creation of variants in a version control system database;

FIG. 3 is a flowchart also depicting methods for usage and creation of variants in a version control system database;

FIG. 4 is a block diagram of system modules that can be utilized to implement the variant management system;

FIG. 5 illustrates mapping and reverse mapping of assets in the software asset repository and versioned files with variants;

FIG. 6 illustrates how variants can be displayed to a user consulting the versioned files;

FIG. 7 illustrates coding of software variants in a variant control system (VCS) including a process when a user can make changes to sub-portions of files; and

FIG. 8 illustrates coding of software variants in a VCS, where the system can check into the version control system and the variant selected by the user.

### DETAILED DESCRIPTION

The following is a detailed description of the embodiments depicted in the accompanying drawings. Arrangements in the form of systems, apparatuses, methods and computer readable media are disclosed herein that can provide code revision management.

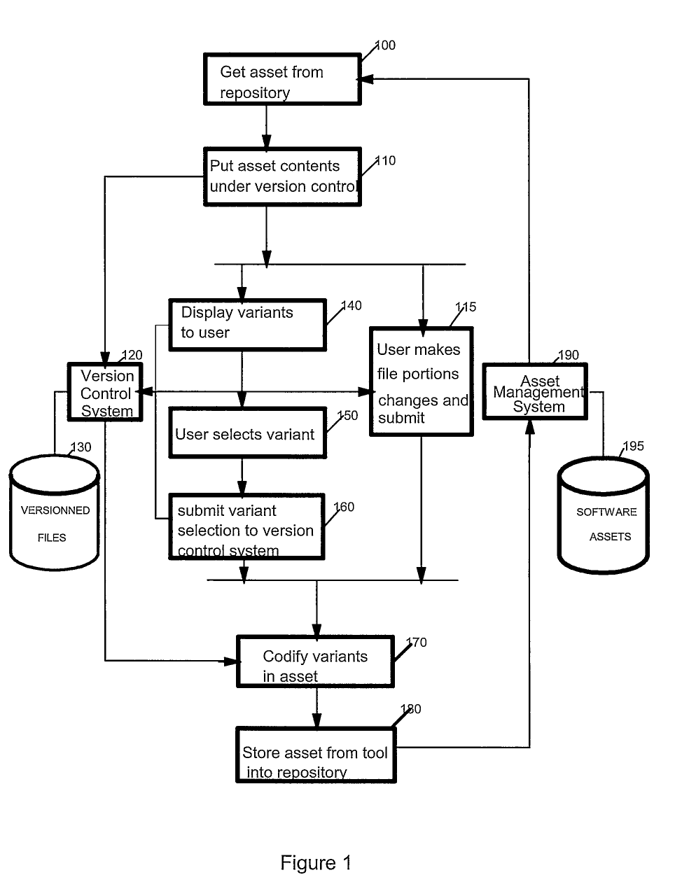

FIG. 1 is a flow diagram depicting methods for management of variable assets or code variations. Such management features allow a software developer to search for, locate and utilize many different versions of code or artifacts. These stored artifacts can be searched by attributes of the file such as functional descriptions, revisions dates, program names, file types etc. Once located, a programmer can efficiently integrate the artifact into code under development or code that is undergoing revisions. After the artifacts are integrated, a new software asset can be stored, tested and prepared for release or use. Thus efficient access to code or artifacts can be accomplished by revision control, indexing, codification and storage as described with respect to FIG. 1.

A software development environment typically has an asset management system/repository as illustrated by blocks 190 and 195 respectively. The asset management system 190 can index and stores assets and can allow access to the stored assets in a database as illustrated by block 195. As a developer creates code during a software development process, the developer can conduct transactions with versions of code or software assets that are stored in the repository 195. The asset can be an application, a file, an artifact, a variant, etc. referred to herein as a segment of code. The asset can have multiple versions with different capabilities, compatibilities, specialties, etc. It can be appreciated that over time, an original version of asset can spawn a number of different possibly specialized assets that cater to different requirements. It can be appreciated that these different, specialized, or variant assets can be compatible with different architectures, different systems, different software, or provide specialized functions.

The different versions of assets can have attributes or identifiers such as date, function, compatibility, author etc that identify something about the segment of code and over time many assets can evolve from a single asset. Thus, assets that evolve from a single base asset can be grouped as providing a similar result but the way the result is achieved may occur in many different ways. Over time as variations or variants are developed by many developers the disclosed comprehensive variant management system can provide a comprehensive searchable library of assets. Such a library can make a developer's job easier and more efficient. Accordingly, a developer can create code segments and store the code segments as versioned files that are searchable by many different attributes.

In a software design environment a developer can acquire many different pieces of code such as entire applications and add-ons or plug ins that are compatible with each other and the developer can “link” these pieces of code together to create a large suite of processing services. When a developer desires to customized software or to have additional or customized features, to a software product or application, the developer can search for segments of code, to provide such features or customer requirements. After locating code that satisfies the requirements or is a starting point for developing desirable features, the developer can then modify the code and integrate the code into the core application. These segments of code can be artifacts and/or variant artifacts.

Accordingly, during development or modification of code, a developer can acquire a software asset from an asset repository, as illustrated by block 100. The developer can utilize an asset management system 190 to search for, and acquire the asset, as illustrated by block 190. The developer can implement version control on the asset and in some embodiments, can select one or more control features provided by the version control system, as illustrated by block 110. After assets are placed under version control, many different independent operations can be conducted, as illustrated by blocks 120, 140 and 115.

In such version control operations, modifications to an asset or transactions conducted on a segment of code can be determined by a version control module 120 and, such transactions or modifications can be classified, codified and stored in the versioned file repository. In some embodiments, the version of the asset that is integrated into a version of parent software, its modifications and related activities, attributes, functions and parameters can be logged responsive to what version control features are selected.

Stated another way, when an asset is placed under version control in block 110, the version control system 120 compare an asset in the repository to the modified version can determine changes, create attributes of the changes, index such changes and store the attributes and changes in the versioned file repository 130. As illustrated by block 170, attributes and parameters can be created based a compare of the version that was checked out of the repository and what is check into the repository and such attributes and parameters can be utilized to classify or codify the transactions or codify the variants. In some embodiments, the version control system 120 can perform the classification and codification 170 of code and attributes, and the version control system 120 can store such data in the repository as illustrated by block 180.

In some embodiments, the asset management system 190 can be utilized to facilitate storage of the assets and attributes in the asset repository 195. The asset repository can be configured as a relational database and the assets, variants, attributes etc., can be indexed, organized, mapped, etc., to provide easy searching and access to the asset repository 195. Thus, a relational database structure can be implemented to provide mapping between parent assets, variants and artifacts and between related versions of parent assets, variants and artifacts.

Thus, different types of code and different versions of same type of code can be associated utilizing mapping functions. For example, a generic asset such as an accounting program can be mapped to multiple variants or multiple segments of code where the multiple variants may have been utilized with the base or generic asset. In some embodiments, mapping can be conducted by the version control system 120 and the mapping configuration can be stored by the versioned files repository 130. The mapping could also be created and updated by the asset management system 190 with version control functions handled by the version control system 120.

The disclosed features are very flexible and can operate in many different ways. For example, version control can be achieved independently of features provided by the asset management system 190. The assets stored in the asset repository 180 may or may not contain variability points and the asset under version control by the VCS 120 may or may not contain variability points. Parameters and attributes of the code can indicate such a link between variability points, assets revisions, etc. For example, in block 170, the changes or variants can be indexed or codified.

Referring back to block 110, when the development system has been placed in a version control mode and the system has been operated in a version control mode, useful data can exist in the versioned repository 130 and the asset repository 195. The heavy lines below block 110 and above block 170 indicate a development mode or module. As illustrated by block 140, a developer that is searching for variants that can fulfill a specific need, can make a search request based on functional descriptions, parameters and attributes. Thus as illustrated by block 140, in response to a developer request to browse variant parameters, attributes or files, variants or versions of code can be displayed. The version control system 120 can assist in providing information to be displayed. In some embodiments, a user can select one or more variants being requested, searched, or displayed, as illustrated by block 150. As illustrated by block 160, the variant selected can be submitted to the version control system.

Again referring back to block 110, when the development system has been placed in a version control mode and the system has been operated in a version control mode, a developer can make file portion changes and the changes can be submitted to the version control system 120. The system can codify each variant by storing two revisions; a before and an after versioned file containing the variants. The variant files can provide two ‘snapshots’ of the versioned file or, the before modification and after modification version of the artifact that corresponds to the variant. The variant content can then be acquired and/or defined by comparing the content of each file and determining the difference between these two files or the two versioned files or revisions.

The first variant revision of the versioned file may have no variant content, and the second variant revision may have variant content. In such a configuration, the variant content can be defined as the difference between the two file versions or variant revisions of the versioned file contents. It can be appreciated that a developer can view, select and compare any number of revisions of a versioned file and determine the differences and index and/or codify the changes. When there are more than two revisions to compare (and to codify variants), the variant content can have more than one difference.

Accordingly, as illustrated by block 115, the developer can read a versioned file wherein variants in the file can be coded with functionality, parameters and attributes, and can make modifications to the versioned file content and the coding. Generally, such features allow a developer to submit modifications and such modifications can be stored by the version control system 120. The branch from block 110 to block 115 depicts one approach for managing variants. As illustrated by block 115, the user can update versioned file content by identifying a portion of a file or instance portions of the code, if the versioned file contains code, and can make changes and submit such changes to the version control system. However, the developer does not have to work explicitly with variants. A developer working with variants can utilize a keyword when submitting a change to the version control system 120. They keyword may indicate a change in functionality for the new variant. Further, the keyword can be stored or recorded as a change that identifies a newly produced variant. The keyword can identify more than a standard code change and the keyword can be implemented such that the keyword does not have an impact on the variant or any variant.

The middle branch through blocks 140, 150, and 160 provides features for working with variants. For example, a particular variant can be chosen from a set of variants, via a variant graphical user interface that displays selectable variants of a versioned file to the developer. Thus, the developer may choose one variant for usage in development, as illustrated by block 150. The selection can be submitted to the version control system 120, as illustrated by block 160, which can then code the selection as a variant in the versioned file and codify the variant as an asset, as illustrated by block 170.

For both branches, via blocks 140-150-160, and via block 115, the development framework can index the variants and the attributes of the variants stored by the version control system 120 as illustrated by block 170. Accordingly the version versioned file and the software asset(s) and all associated data can be stored in the asset repository 195 and the versioned repository, as illustrated by block 180.

It can be appreciated that the developer can manipulate file content with a traditional editor, a graphical user interface or a domain user interface before submitting the modification to the version control system 120 in the branch with block 115. The middle branch illustrated by blocks 140 to 120, blocks 140, to 160, or blocks 140 to 150 to 160, allows a developer, to compare variants and get a difference between the variants as illustrated by block 170, where the differences in variants can be stored under the assent management system 190 in the asset repository 195.

In addition, the developer can modify the variant of the versioned file or add attributes or keywords, and then compare variants to create the codification variants of a versioned file via a user interface. Such a feature allows a version control system to determine and process variants. The user interface can display all the variant contents of a versioned file and thus can allow the developer to work explicitly with variants by creating new variants or updating existing variants.

In summary, one or more revisions of a versioned file having variants can be tracked via the version control system 120. The version control system 120 can index and code the revision or indicate that the revision is an asset artifact having variants as illustrated by block 170. The variants can be described or indexed based on data including variability points and parameters, attributes and/or functional and non-functional descriptions such that the variants are identifiable, searchable and retrievable. Such descriptions can be stored under the control of the asset management system 190 in the asset repository 195.

It can be appreciated that a “reverse” of the described operation can occur where an asset artifact with variability points having variants, can be presented to an asset management system and the management system can code an asset artifact as a revision of a versioned file. An asset artifact can be coded as a revision by coding the variants with two “special” revisions of the versioned file (the ‘variant revisions’) and a logged comment including an identifier of the variability point via the version control system 120.

Such features can be legacy compliant as the developer can utilize a legacy version control system to browse or view revisions of versioned files in the file database 130 or asset database 195. Such disclosed features can also create variant revisions in the repositories or databases and can index and store user generated comments for the variant(s). Such comments can include one or more keywords, dates, authors, or identifiers for one or more portions of code where such comments can be attributes. Many of the attributes can be auto generated by the disclosed system.

A legacy version control system can be utilized to support variants and the legacy version control system can also support and provide traditional revision management. Management of variants can be accomplished via a domain based user interface, via a legacy user interface or a newer user interface, such as a graphical user interface that allows for improved management selections and for management of the variants in accordance with blocks 140, 150, and 160, can provide improved performance for developers.

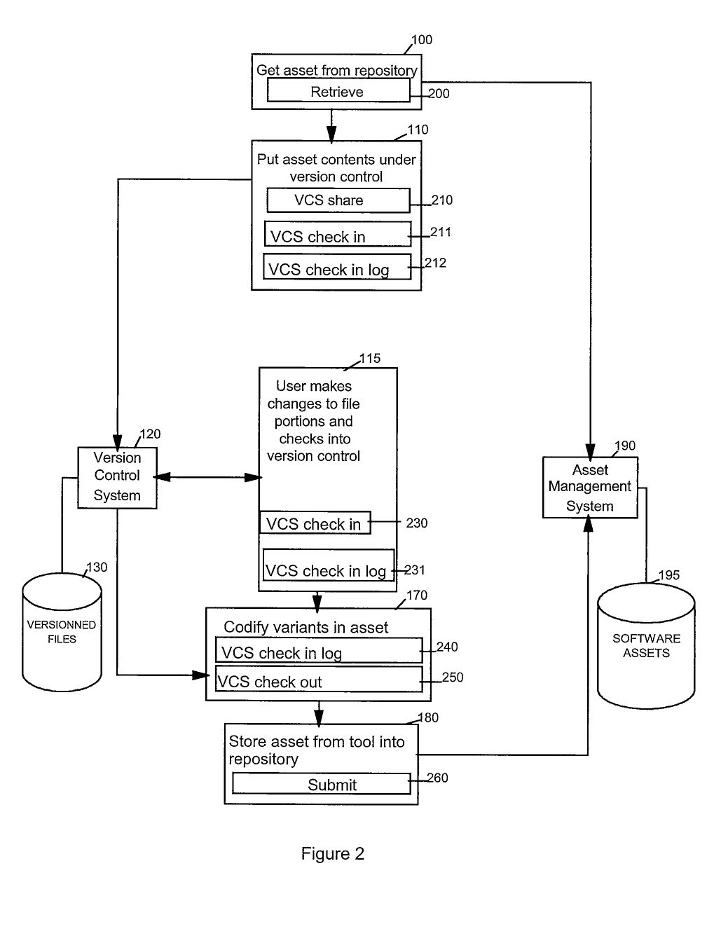

FIG. 2 is a flow diagram depicting a method for creating variants and managing variants in a version control system utilizing an asset repository and/or one or more databases. Accordingly, features and functions of an asset management system, operating in cooperation with a version control system is described below. In some embodiments, an IBM RAS V2.2 based asset management system and an IBM Rational ClearCase version control system can be utilized to implement the described features.

As illustrated by block 100, an asset can be acquired or retrieved from a software asset repository utilizing a ‘Retrieve’ command, as illustrated by block 200. The asset can be an asset which has not been compared to other versions and does not have revision history and thus, does not have attributes. Conversely, the asset being processed can have an extensive revision history and many attributes.

If the asset has already been “processed” or has been placed in the repository, the asset may include attributes of variants where such attributes can include variability points. Variability points and artifacts can be defined as standard objects that can be utilized by the asset management system to structure where revisions or segments of code can be located within applications. In some embodiments, the disclosed asset management system 190 can utilize variability points to define what variants are available and what distinguishable functions the variants provide. Such a feature can create a log showing an evolution of assets or artifacts and for each version of the asset or artifact, one of more attributes can define features of the asset that are different than other versions.

Accordingly, a developer that desires to locate a specific feature for a specific variability point can search one or more repositories for a desired asset or for a starting point for modifying or developing a new asset or application. Searching for variability points or for functional features using keywords that describe functions etc. can assist a developer in quickly locating useable segments of code. Accordingly, the disclosed system provides an efficient locating tool and most of the operations to build such a system are conducted by background processes that are transparent to the developer.

As illustrated by block 200, retrieving the asset can be performed by the asset management system 190 and in some embodiments the variants can be defined by variability points in the variant and what function(s) occurs at the variability point. Also in block 200, definitions having variants that are part of the asset model(s) can be obtained by the variability points. The definitions can be obtained utilizing mapping function.

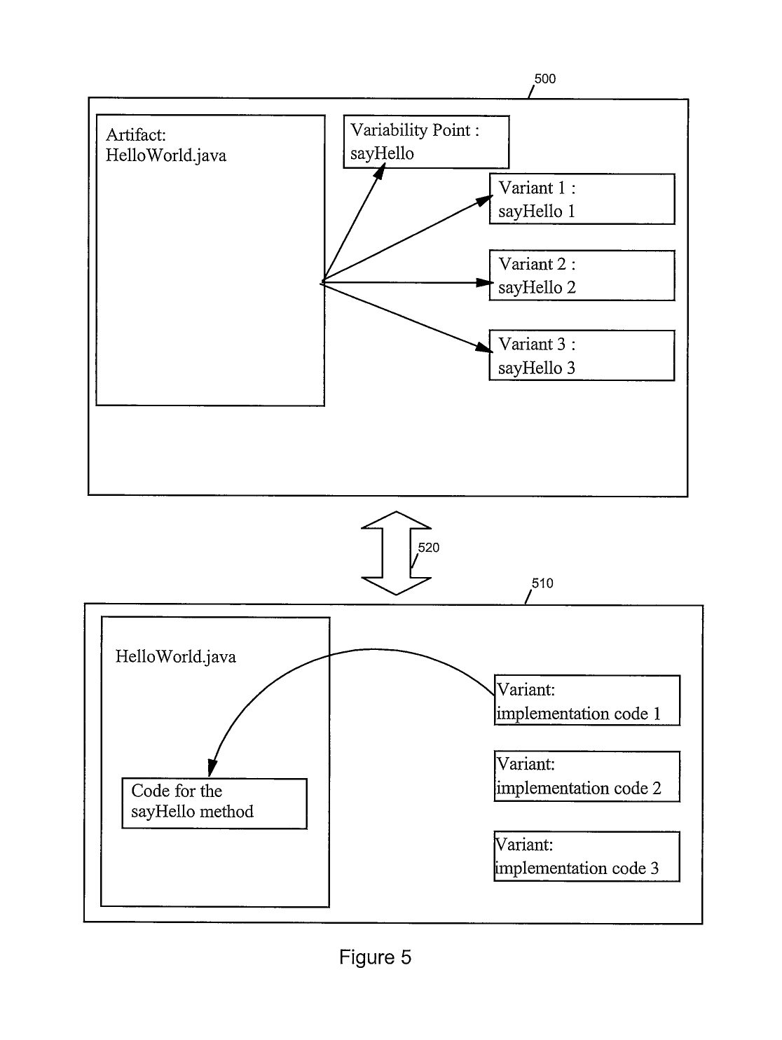

Referring briefly to FIG. 5 methods for obtaining definitions is described. Mapping and reverse mapping of assets to versioned files is described below. Assets can reside in the asset repository 195 and artifacts can be stored I the versioned repository 130. As stated above, variant definitions can be stored in the asset repository 195 as depicted in block 500. HelloWorld.Java is illustrated as an artifact, where the artifact HelloWorld.jave has a variability point of “sayHello.” The variants depicted are sayHello 1-3, however many more variants could be created and stored. Accordingly, multiple variant definitions can be mapped to an artifact for a Java class such as the Java class HelloWorld.java. The Java class can contain variability points for variants for a multiple sayHello segment of code or multiple sayHello methods. The variability point is indicated generally, by the three blocks with the text, sayHello 1, sayHello 2, and sayHello 3.

As stated above, in the description of FIG. 2, an asset model or an artifact model such as model 510 can be created. The model can include multiple variants for a single segment of code or artifact. Double direction arrow 520 between blocks 500 and 510 indicates that the mapping operation can occur in both directions from asset repository to version repository and from version repository to asset repository. A “reverse” operation can include identifying a variant model associated with an asset related when the asset description is stored and the asset description can include variability points to represent the variant.

Referring back to FIG. 2, after an asset model or artifact is sufficiently defined and/or identified, the artifact can be stored in the software asset repository 195. As illustrated by block 110, the software asset can be placed under version control. A copy of the asset can be sent to a requester utilizing a “share” command as illustrated by block 210. The share command can be viewed as a check out process where the repository sends a copy of the asset to a requesting developer. The version control system 120 can support management of assets that are sent to a developer or “checked out” and can manage or track these derivative assets or variants that checked in or received back from the developer and can “check in” such “new” assets. In some embodiments, the version control system (VCS) 120 can perform a VCS check out process 210 and check in process 211. As illustrated by block 212, differences of the checked out and checked in versions can be logged as illustrated by the “VCS check in log” block 212. If the asset to be checked in contains variations or variants, attributes can be created automatically and/or via user input and such attribute data can be codified and mapped to assets in the asset repository 195 and the file versions in the versioned file repository 130.

Such a mapping process by the version control system 120 can utilize data on each variability point in the asset and can utilize one or more variability points, keywords, attributes, values etc. to index, log etc. new versions of code as the code/variant is checked into the repositories 130 and 195. The attribute data can be utilized to assist in version control features for some or all variants and variability points. In some embodiments, a revision file can be created for one or more variant artifacts stored in the repository and the revision file may not have variant data when it is originally created. Such a file can be created by the version control check in function illustrated by block 211. It can be appreciated that many “new” revisions or new versions of the file artifact can be created where the file contains the same or substantially similar “variant” data.

During the check in process illustrated by block 212, a user or developer can utilize a user interface to enter comments including functional descriptions, or changes made and a user can associate the comments with the revised code being placed into the repositories 130 and 195. When a developer enters one or more unique comment as part of the check in check in log function of block 212 of selects a particular function the stored revision can be tagged as a ‘special revision.’

In some embodiments variants can be defined as a part of or a portion of an artifact. It can be appreciated that a group of functionally related variants can be interchanged or freely substituted at a variability point and thus a group of variants can be mapped to, assigned to, or can be common to a single variability point of many variability points. To assist in searching and viewing specific functionality of artifacts or content for a specific portion of code or model, variants can be indexed with file revision indicators. As described above, variant content can be quantified by determining the difference(s) between two versions of code, where the two versions can be associated with a common or shared variability point. As stated above, keywords can be utilized to identify and locate versions that are compatible with the base application, provide specific functions and are associated with a particular variability point. Such keywords could be part of an IBM RAS specification.

In some embodiments, the ‘VCS check in log’ functionality, as illustrated by block 212 can be utilized to attach a comment to a revision or to map a comment to one or more files. Logging functional aspects of the version could be referred to as ‘logging a keyword’ for one or more revisions. The keyword can be considered a form of annotation that is supported by most version control systems. For example, such annotation capability is referred to as a ‘comment’ in IBM's ClearCase product, and such a process can also utilize ‘tags’ to provide such version control. As previously mentioned, a keyword can be utilized to uniquely identify a variability point, functionality or title a group of variants. The keyword can be equal to, or mapped to a variability point identifier which can be stored as part of the asset.

After a developer checks out a file from the version control system 120, then, a ‘check in’ can be performed as illustrated by block 230. As illustrated by block 115, a developer can make changes to files segments of code or variants possibly to update portions of the versioned file. The developer can check in the modified code to the version control system 120. The changes to the file portions can be entered by the developer through many different development tools. Such tools can be configured to store and share the development artifacts in the version control system 120. The development tools can be an editor or a software development tool such as a wizard.

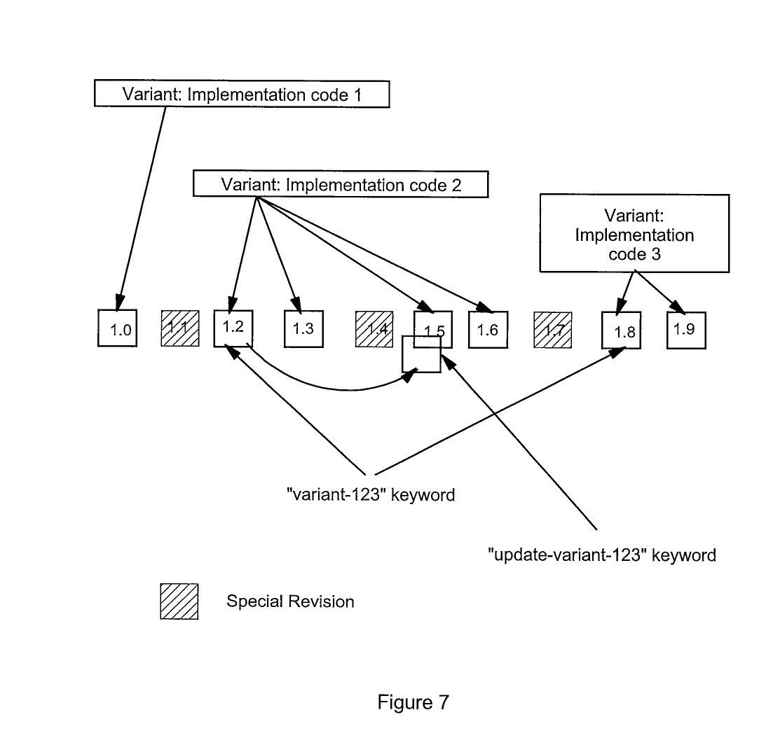

The check in process of block 230 can include the version control system 120 accepting changes by the made by the developer. The check in process can code variants in a specific way and such coding can be utilized to store a versioned file. Such coding of variants can implement the ‘special revision’ or variant revisions as described with respect to FIG. 7.

As stated above, during check in of a variant as requested by a developer, as illustrated by block 230, the developer can add keywords or other data as a comment. For example, a comment of “<value_of vp-uid>” can be utilized to specify that a change made by a developer provides a new variant for the identified variability point. Accordingly, the check in log function, as illustrated by block 231, can include querying a developer, allowing a developer to decide whether the version that was checked out should be overwritten with the document to be checked in. If the developer selects not to overwrite the checked out version then the modified code can be stored as a variant. Accordingly, the “original” or checked out version will not be “deleted” and/or replaced with the latest revision which was created by or imported by the developer. It can be appreciated that when a developer fixes a software “bug” the developer may want to overwrite a previous version of code that has inherent problems. This feature can prevent problem software from being used by other unknowing developers.

When an original version is overwritten there may not be a version to compare the changed version to and thus no data may exist on some variants. Accordingly, the features described by block 115 can utilize a VCS check in function to create a revision of a retrieved file, where the revision has no variant data.

When software variants are created, the variant can be coded. Referring to FIG. 7, coding of software variants in a version control system is illustrated. In some embodiments a user can make changes to sections of code and save the changes to create variants, versions or revisions. Accordingly, the numbers such as 1.0, 1.1 etc., in the square boxes of FIG. 7 generally represent version numbers of variants. The differences between versions 1.0, 1.1 and 1.2 may be defined as changes described with respect to the HelloWorld and sayHello variant methods depicted in FIG. 5. In version 1.0, the sayHello method can contain implementation code 1 and version 1.2, contains implementation code 2.

In some embodiments a user can supply a variant code that associates a variant or version with a variability point or, associates variants that can be substituted for each other. In one embodiment, when a developer has a check in request for version 1.2, the developer may use the “variant-123” keyword in as a check in comment. Similarly, the “variant-123” keyword can be utilized to check in version 1.8 and so on to create a group of variants. The same keyword can be entered for variants with similar functionality and for variant that can be inserted at the same variability point.

It can be appreciated that a difference between versions 1.1, 1.4, and 1.7, and their respective previous versions (or parent versions) can be that the variant (sayHello) has been removed from the file and thus there is no mapping or association between the different versions. The disclosed processes allow for such association to be generated at any time by comparing versions. Thus, even though a variant has been removed from the repository, the system can reconstruct variant content by comparing two different versions and acquiring the difference(s) between two versions. For example, initial variant code 2 can be the difference between version 1.1 and version 1.2. The system can create these special versions/revisions and such a creation can occur via background operations thus, occurring as a process that is transparent to the user.

The system can use code templates and markers to create special variants where the boxes illustrating special version are cross hatched. In some embodiments code templates can define the structure of a method and a marker can define a line number in the code where the method starts. The method could be a Java method. Special versions are illustrated by versions 1.1, 1.4, and 1.7. Versions 1.0, 1.3, 1.6, and 1.9 can be defined as traditional (non variant) versions.

The “variant-xyz” keyword can be utilized to uniquely identify a variability point where different variants can be inserted this allowing variants to be classified by the variability point. In FIG. 7 one variability point and three variants for the variability point are illustrated however, many variability points and variants could be utilized, and a small number of points and variants are described to simplify the description herein. The same numbers or “variant-123” could be utilized for xyz when checking in version 1.2 and version 1.8. Such a “unique” variability point identifier allows the system to have more than one set of variants in a file artifact.

For example, another set of variants for a sayGoodbye( ) method in HelloWorld.java can be codified with “variant-456.” In some embodiments a developer can be prevented from making changes to anything other than the variant keyword during the check-in process. The system can also support the modification of existing variants as opposed to the modification of code that is not a variant, or the introduction of a new variant. Support of developer modifications to existing variants can be supported with the “update-variant-xyz” keyword as shown by a phantom box next to the box illustrating version 1.5. The variant xyz can be updated when the “update-variant-xyz” keyword is used in the check in comment. In some embodiments, there can be only one variant, e.g., one sayHello method in an artifact file in a given version to simplify system operation.

When an update-123 check in occurs, the system can create a version of a file with no variant-xyz as illustrated by version 1.4. The system can then check in the version submitted by the user and can automatically add a variant-123 in the check in log. As illustrated, the check in log can apply to versions 1.2, 1.5 and 1.8. The system can also remove the previous variant-123 comment from the commit log. The system may look at the difference between versions 1.5 and 1.4 when the system is searching for variant 2.

In summary, the version boxes illustrate that version 1.0 of HelloWorld.Java code contains variant 1, version 1.1 of HelloWorld.Java code does not contain the sayHello code or method and thus, does not contain any variant. Further, versions 1.2 and 1.3 of HelloWorld.Java code contain variant 2 and version 1.4 of HelloWorld.Java code does not contain the sayHello method and thus, does not contain any variant. Yet further, versions 1.5 and 1.6 of HelloWorld.Java code contain variant 2, and version 1.7 of the HelloWorld.Java code does not contain the sayHello method and thus, does not contain any variant. In addition versions 1.8 and 1.9 of HelloWorld.Java code contain variant 3 and versions 1.1, 1.4, and 1.7 are revisions hidden from the user and can only be used by the system. The versions checked in with variant-xyz keyword, can be versions 1.2 and 1.8 after a developer checks in the modified version. The version checked in with update-variant-xyz keyword is version 1.5 accordingly, in step 115 of FIG. 2.

Referring back to FIG. 2, the developer can make a request to store the code containing the newly created variant into a software asset repository for future reuse. This operation is illustrated by blocks 170 and 180. As illustrated by block 170, codifying variants can be considered a reverse operation of putting asset content under version control, as illustrated by block 110. Codifying assets can include reading the VCS check in log 240 containing logs of previous VCS check in operations as depicted by blocks 211 & 230. Codifying can also include utilizing the VCS check out in block 250, which can include coding each file under the VCS's control that contains at least one variant as a file artifact where variability points can be utilized to group the variants.

In summary, the VCS check in log can be read, and for each file whose VCS check in log contains a “variant-xyz” keyword, the file can be stored in the asset repository as a file artifact where HelloWorld.java is the artifact provided herein. As stated above a variability point can be created in the asset, under the file artifact, such as variabilityPoint-123. Further, a latest version of the file can be obtained, such as HelloWorld.java v1.6, and a variant artifact can be created under the file artifact corresponding to the appropriate version. For each variant-xyz keyword in the check in log (e.g. variant-123) file revision changes can be obtain (e.g., HelloWorld.java v1.6) and the revision of the file artifact can contain the variant data. Further, the previous file version can be obtained that corresponds to the check in (e.g., 1.4) where the revision of the file does not contain variant data information and a variant artifact can be created under the file artifact (the content of this variant artifact can be is built by analyzing the difference between the two revisions described above).

After codifying variants in block 170, the asset can be codified as an asset with variability points corresponding to variants. The asset may then be stored, as illustrated by block 180, by a SUBMIT function by the software asset management system 190 and 195. The SUBMIT functionality can support the ‘variant model’ illustrated in FIG. 5 by moving from the configuration described in block 510 to the configuration described in block 500 where the variant model can be applied to the newly defined software asset.

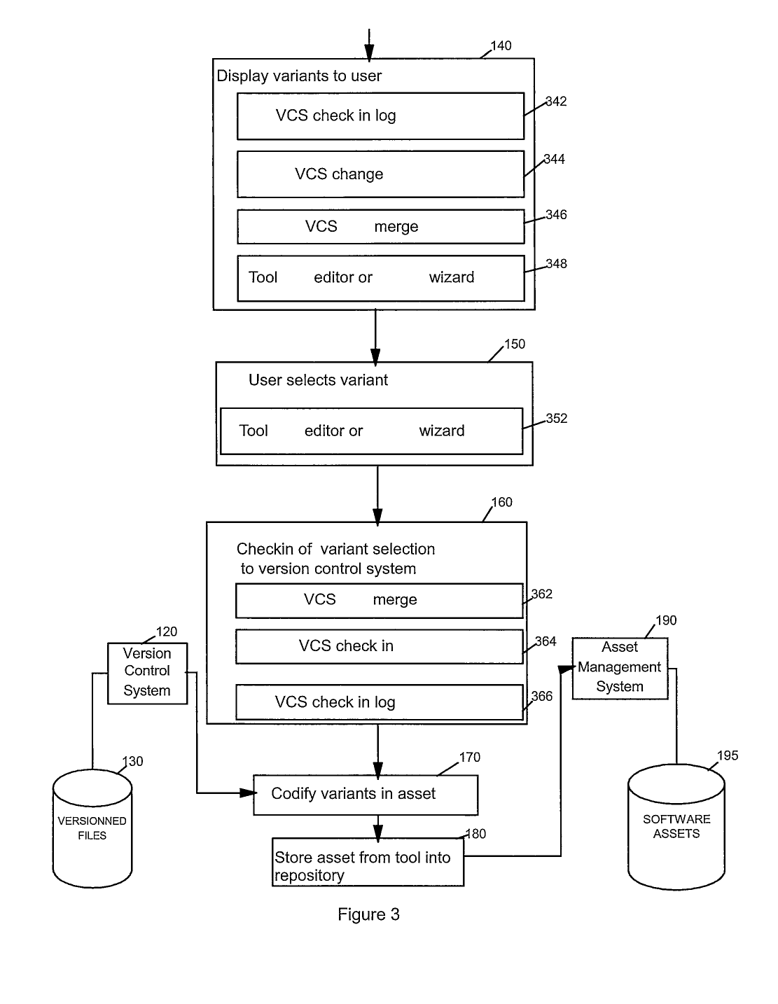

FIG. 3 is a flow diagram illustrating usage of variants in a version control system that utilizes a database. FIG. 3 further explains the branch in FIG. 1 that includes blocks 140-160 where a developer can create or update variants by utilizing a software development tool that can manage variants in software artifacts. Development tools can allow variants to be codified under a version control system and the codified variants can then be searched retrieved and displayed to the developer in a useful manner.

As illustrated by block 140, a VCS check in log containing the logging of a previous check in operation can be read, as illustrated by block 342. The system may look for the check in log of the versioned control system and may read the “variant-xyz” keywords based on a search for artifacts that are associated with a variability point. A search can provide artifacts that are associated with a distinct “variant-xyz” keyword such as variant123, as illustrated by block 344, and the VCS can merge the changes, as illustrated by block 346. The changes can be displayed via the development tool, an editor or a wizard, possibly in a tree configuration, as illustrated by block 348. A code snippet illustrating a point of difference, or specific functionality could also be displayed to a developer to illuminate a specific variant trait.

Such a process to display of variants can be described generally as follows: Read the version control system's check in log; for each distinct value, (“variant-xyz” in the commit log (e.g. variant-123)), obtain the file changes made to artifact; create a variability point in memory (e.g., vp123) and; for each “variant-xyz” commit (e.g., 1.2), obtain the revision created by this commit (1.2; this is the revision of the file that may contain variant data information). Next, obtain the previous revision which can define the baseline used for defining the content of the variant (e.g. 1.1; this is the revision of the file that does not contain any variant data information); create a variant corresponding to the difference between these two revisions (e.g., variant 1); associate the code portion (snippet) to that variant and; obtain the latest revision of the file (e.g., HelloWorld.java v1.9. The latest version of the file can contain variant data information. Then, obtain the revision defining the baseline used for defining the content of the variant (e.g. 1.1; this is the revision of the file that does not contain any variant data information), and create a variant corresponding to that version (e.g., variant 3), by looking at the difference between these two revisions.

The variants can be displayed in a file tree format organized by one or more variability points. The system can display a portion of code portion that is associated with the variant in response to a developer selecting a variant via a tree format. In some embodiments the developer can select a variant by using a graphical user interface tool, an editor or a wizard, as illustrated by block 352. The developer can request and view keywords, functional definitions and possibly a code snippet in a tree format based on the display contents described above. The developer can then choose a variant and indicate that the developer wants to proceed to plug the variant into a particular variability point.

As illustrated by FIG. 3, when the versioned file is stored by the versioned control system with the variant chosen by the developer, as depicted by block 160, a corresponding asset can be created. This creation of an asset can take place in the software asset repository according to the variant codification block 170 and the asset can be stored into the repository 180 as previously described.

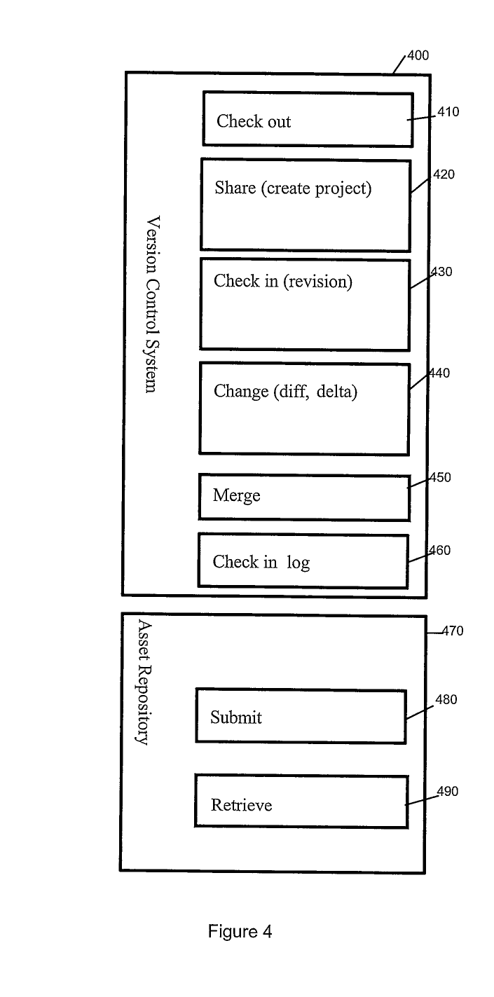

Referring to FIG. 4, a block diagram describing the different functions of the version control system 400 and the asset repository 470 is illustrated. The version control system can include a check out module 410, a share module 420, a check in module 430, and a change module to determine differences between revisions 440, a merge module 450 and a check in log 460.

The blocks of FIGS. 1, 2 and 3, have a descriptive overlap with the blocks of FIG. 4. For example, the check out module 410, (see also blocks 170 and 250) can retrieve a revision of a file from the versioned file database so that the revision can be modified by a developer. The share module 420 (see also block 110 and 210), can perform a VCS operation to make a set of resources worked on locally, available for concurrent use by other developers. The share operation can consist of loading the resources into the VCS and implementing a “Share a project” capability.

The check in module 430, (see also blocks 110, 211, 115, 230, 160 and 364) can copy a local revision of a file back to the versioned file database after modifying the file locally. The change module (see also blocks 440, 140 and 344) can analyze the text differences (or deltas) between any two revisions of the same file or directory. The merge module 450 (see also blocks 140, 346, 160, and 362) can merge the changes made between any two revisions of a file or directory into another revision of the same file or directory.

The check in log module 460 (see also 170, 240, 140, 342, 160, and 366) can apply one or more attributes to a revision or collection of revisions where the attributes could be one or more keywords, variability points, tags and/or comments. Such attributes could be an arbitrary text string that is attached to the file. Tags or comments can be attached or deleted by standard functions of a VCS. The time for association and/or attachment of attributes, tags or comments can for example, be accomplished when checking a file revision into the repository, or after the file revision has been checked in. The comments can be placed into the check in log and later the check in log can be browsed by a developer and attributes can provide an efficient way to locate specific revisions with desirable properties. For example, work by a developer that creates a change in a function could prompt the developer to add a comment defining an attribute with a keyword, that describes a change in function and a compatibility statement.

The check in module can also include a codify variants module (see blocks 170, 240, 140, and 342) for a given file. The revisions can be tagged or commented with “variant-xyz. Such a tag or comment can be listed by browsing the VCS check in log. Such a feature allows event records to be listed in a user friendly format. For example, the “create version” event records written by the previous check in commands can contain the “who, what, when, where, why” of each operation, including the supplied comment (e.g. “variant-xyz”). This list can be filtered out based on the value of the comment. The “submit variants”, as described with respect to blocks 160 and 366, and the appropriate “variant-xyz” tag/comment can be associated with the appropriate file.

The asset repository 470 can include a submit module 480 and a retrieve module 490. The submit module can submit code to be stored by the asset repository and the retrieve module can efficiently retrieve code as requested by a developer or another system.

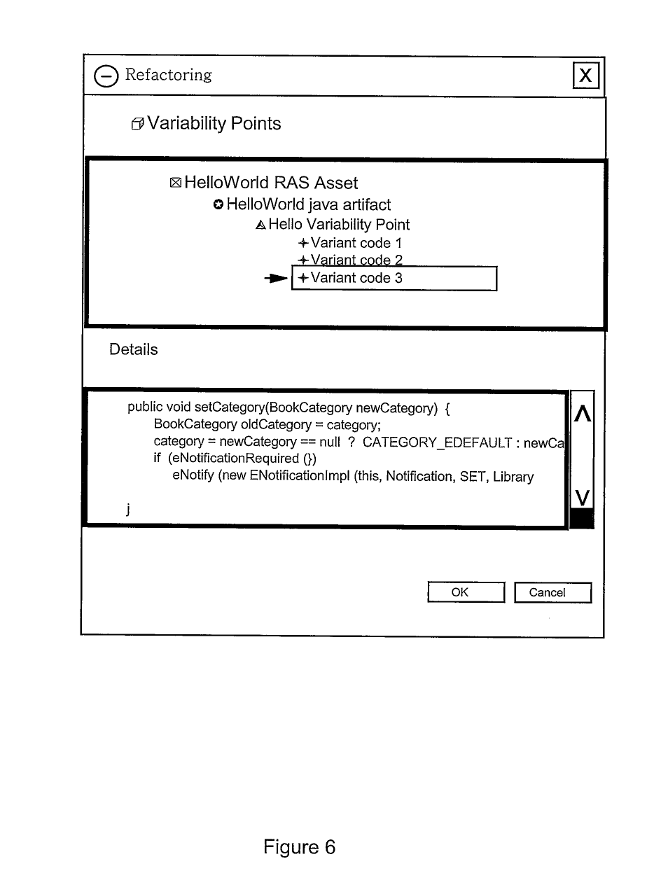

FIG. 5 was discussed above, so referring to FIG. 6 a format for displaying variants to a developer browsing versioned files is depicted. Three variants (variant codes 1, 2, and 3) are displayed for a HelloWorld.java artifact in the upper window of the screen. In some embodiments, a developer can click on or select ‘Variant code 3’, and details of the selected Variant code 3 can be displayed in the lower window. From the bottom of FIG. 6, a developer can select OK, and by activating the OK selectable button the developer can confirm a selection of variant code 3. Such a selection process can retrieve or “bring up” an asset, variant of artifact. The developer can also create a variant by typing in content of this variant, for instance typing in a portion of code and the developer can select the code as a variant to be stored.

In some embodiments, by selecting a variant, no new variants will be created or updated, however an existing variant can be chosen for a portion of a file or a substitution for a revision of a versioned file. This variant selection can be called a ‘variant bind’, ‘variant set’ or ‘user select variant’ operation. The variant selection can be checked into the version control system and such a check in can be considered as the reverse of displaying variants from a versioned file containing variants to the developer.

The selected variant can have the developer's changes merged from the selected variant and the developer's selection can be codified into the versioning system. Utilizing the VCS check or compare the versions and can include the selected variant into a new version of the file created from the last version. When codifying variants under the versioning system, it can be ascertained that the variants are correct and the correct variants can be logged in a check in operation.

In summary, file variants can be obtained and the variants can be applied to the artifact, for example, HelloWorld.java v1.9. A revision can be created, where the revision defines a baseline, where the baseline can be utilized to define the content of the current file. The new revision may not contain any variant data information achieved by removing content of earlier versions from a later versions, (i.e. removing revisions between 1.7 and 1.8 from revision 1.9). Next, code from the selected variant can be merged (e.g., code snippet from 1.1) into the file. Such a feature can be achieved by applying the differences between the revisions, for example between version 1.0 and version 1.1, to the file revision content 1.10. Further, a new revision can be checked into the file (e.g., 1.11), utilizing the variant-xyz keyword. In addition, the variant-xyz keyword can be removed from the commit where the next variant can be added (1.0) and the differences between the new types of versions, (which are revisions hidden from the user and only used by the system 1.1, 1.4, 1.7 in the example of FIG. 7) can be removed. The versions created by the variant checking operation (1.5 and 1.8 in the example of FIG. 7), can be utilized to find the code portion (fragment) to be utilized for substitution. The implementation can be based on IBM's ClearCase merge processes and version control capabilities.

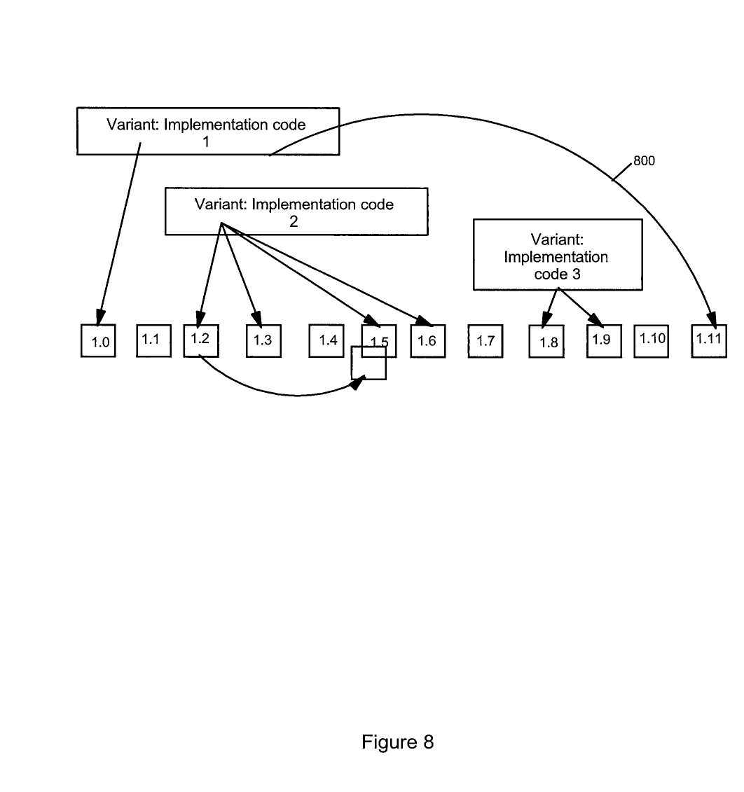

FIG. 7 was described above, so referring to FIG. 8, coding of software variants in a VCS is disclosed where the a check in process can occur based on a developer selecting and modifying a piece of code to be checked in. As described above, a selected variant can be a variant such as one found inside of HelloWorld.java. When a developer selects a variant implementation of code such as implementation 1, a VCS can conduct a merge operation and can merge a section of code from implementation code 1 into the HelloWorld.java artifact instead of merging a segment of code from implementation code 3.

In operation, a version of HelloWorld.java as described above, can be created. Such a HelloWorld.java artifact can be created that does not have a sayHello( ) method (1.10) or artifact. The changes made between version 1.0 and version 1.1 can be removed and the changes made between 1.0 and version 1.10 (e.g. cleartool merge-to <versioned file name>-delete-version 1.1) can also be removed.

Changes to version can be removed using the disclosed version control system, as the system can apply the changes between 1.1 and 1.0 (note the reverse order) to version 1.10 (e.g. cvs update-j 1.1-j 1.0). These changes can produce version 1.11 via line 800. The latest version 1.11 can contain the latest HelloWorld.java, with the variant sayHello implementation of code 1. In FIG. 8, 1.8 and 1.9 versions of HelloWorld.Java code contain variant 3. Version 1.10 can be considered a revision hidden from the user and only used by the system. In version 1.10, the HelloWorld.java code does not contain a sayHello( ) method (it does not contain any variant). In version 1.11, the HelloWorld.Java code contains variant 1.

The code based operations provided above can be considered independent of all version control systems. The disclosed features can create as many variant artifacts as there are “variant-xyz” that have been checked in. When using artifacts for the asset codification, the process complexity can be reduced because all of the changes made to a file in the version control system can be contained in a single file (e.g., HelloWorld.java, v). In some embodiments, the only artifact to be packaged under the file containing variants (e.g., HelloWorld.java) can be called the CVS file (e.g., HelloWorld.java,v), as opposed to one file artifact per variant.

The method can take any form suitable that can be utilized by or in connection with any data processing resource, such as external or resident software, firmware, or microcode (either in object code or in source code, for example, to be compiled or interpreted). A possibility may be to provide the program on any computer-usable medium; the medium can be any element suitable to contain, store, communicate, propagate, or transfer the program. For example, the medium may be of the electronic, magnetic, optical, electromagnetic, infrared, or semiconductor type. Examples of such medium may be fixed disks (where the program can be pre-loaded), removable disks, tapes, cards, wires, fibers, wireless connections, networks, broadcast waves, and the like. Some embodiments can be implemented with a hardware structure (for example, circuits integrated onto a semiconductor material), or with a combination of software and hardware. A possibility may include being able to deploy the disclosed embodiments as a service that can be accessed through a network, such as the Internet.

The proposed method may be carried out on a resource having a different architecture or including equivalent units, for example, based on a local network. Each computer may include similar elements, such as cache memories temporarily storing the programs, or parts thereof to reduce the accesses to the mass memory during execution. A possibility may be to replace the computer with any code execution entity (such as a PDA, a mobile phone, etc.), or with a combination thereof (such as a multi-tier server architecture, a grid computing infrastructure, and the like.)

Embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution resource. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

1. A method comprising:
retrieving a versioned file from a repository;
modifying content of the versioned file to create a variant of the versioned file;
comparing the variant to the versioned file;
determining at least one difference between the versioned file and the variant;
assigning one or more attribute to the at least one difference:
associating the one or more attribute with the variant; and
indexing the one or more attribute such that the one or more attribute can be located in response to a search.

2. The method of claim 1 wherein the attribute is a variability point.

3. The method of claim 1 further comprising searching for the variant.

4. The method of claim 1 further comprising mapping the one or more attribute to the variant in a relational database format.

5. The method of claim 1 further comprising utilizing a graphical user interface to locate variants.

6. The method of claim 1 further comprising utilizing a graphical user interface to search, select and retrieve variants.

7. The method of claim 1, further comprising searching for the variant utilizing a keyword search.

8. The method of claim 1 further comprising checking out a versioned file from a repository based on a user request.

9. The method of claim 1 further comprising checking in the modified content and logging at least one difference between the variant and the versioned file.

10. A system comprising:
a repository to store segments of code;
a check out module to check a first segment of code out of the repository;
a check in module to check in a second segment of code that is a modified version the first version of code;
a compare module to compare the first segment of code to the second segment of code and to identify changes between the first and second segment of code; and
an index module to index the identified changes.

11. The system of claim 10 further comprising a search engine to search the repository in response to a user search request

12. The system of claim 10 further comprising a graphical user interface to display selectable buttons and to accept user commands.

13. The system of claim 10 further comprising an asset management system coupled to the repository.

14. The system of claim 10 further comprising a version repository coupled to the index module and a version control system coupled to version repository.

15. A computer program product comprising, a computer readable storage medium including instructions that, when executed by a processor:
retrieve a versioned file from a repository;
modify content of the versioned file to create a variant of the versioned file;
compare the variant to the versioned file;
determine at least one difference between the versioned file and the variant;
assign one or more attributes to the at least one difference;
associate the one or more attribute with the variant; and
index the one or more attribute such that the one or more attribute can be located in response to a search.

16. The computer program product of claim 15 that when executed by a processor causes the computer to search for variant useable at a variability point.

17. Then computer program product of claim 15 that when executed by a processor causes the computer to search for the variant utilizing a keyword.

18. Then computer program product of claim 15 that when executed by a processor causes the computer to configure variant data in a relational database format.

19. Then computer program product of claim 15 that when executed by a processor causes the computer to utilize a graphical user interface to locate variants.

20. Then computer program product of claim 15 that when executed by a processor causes the computer to replace the first segment of code with a third segment of code and to log changes to the versioned file.
